(19) United States
(12) Patent Application Publication
(10) Pub. No.: US 2023/0053075 A1
(43) Pub. Date: Feb. 16, 2023

(54) WATERPROOF AND SHAKEPROOF ELECTRONIC SMART RECREATIONAL VEHICLE LOCK

(71) Applicant: SCOKE SMART HARDWARE (SHAOXING) CO., LTD., Shaoxing (CN)

(72) Inventors: Huiliang LU, Shaoxing (CN); Weilong LU, Shaoxing (CN)

(21) Appl. No.: 17/869,839

(22) Filed: Jul. 21, 2022

(30) Foreign Application Priority Data
Aug. 16, 2021 (CN) 202110934901.8

(51) Int. Cl. E05B 83/44; E05B 77/34; E05B 81/04; E05B 81/82; E05B 85/02; E05B 79/08

(52) U.S. Cl. CPC E05B 83/44; E05B 77/34; E05B 81/04; E05B 81/82; E05B 85/02; E05B 79/08

(57) ABSTRACT

Disclosed is a waterproof and shakeproof electronic smart recreational vehicle lock, comprising a lock body and an inner handle assembly connected with the lock body; the lock body comprises a base, a fixed cover, a first locking structure and a second locking structure, the fixed cover and the base are assembled in a buckled mode, and a mounting cavity is formed between the fixed cover and the base; and the inner handle assembly is mounted on a back surface of the fixed cover, the inner handle assembly comprises an inner plate, an inner handle and an unlocking knob, the inner plate is connected with the fixed cover, the inner handle is assembled and connected with the first locking structure, and the unlocking knob is assembled and connected with the second locking structure. The electronic recreational vehicle lock has the characteristics of high sealing and waterproof performance and shaking resistance.

### CROSS REFERENCE TO RELATED APPLICATIONS

This application claims foreign priority of Chinese Patent Application No. 202110934901.8, filed on Aug. 16, 2021 in the China National Intellectual Property Administration, the disclosures of all of which are hereby incorporated by reference.

### TECHNICAL FIELD

The present invention relates to the field of locks, and more particularly, to a waterproof and shakeproof electronic smart recreational vehicle lock.

### BACKGROUND

Since a recreational vehicle is used outdoors in different harsh environments for a long time, a recreational vehicle lock is exposed to wind and rain for a long time, thus being easy to subject to water ingress. For example, in an existing recreational vehicle lock, there is a poor overall sealing and waterproof performance, and parts arranged behind a base are directly exposed to the outside without sealing protection, so that in the case of external water ingress, the parts may be directly eroded.

For another example, in an existing electronic recreational vehicle lock, a plurality of sound production holes are formed in the base, and sound is sent out from the sound production holes, but similarly, outside rain water may flow into the inside through the sound production holes.

Moreover, when used outdoors, the recreational vehicle may run under different road conditions. When the road condition is poor, the recreational vehicle may be bumped, and the parts inside the recreational vehicle lock may shake and make an abnormal sound, thus affecting a driving comfort. Meanwhile, long-term shaking of the parts may also cause looseness, thus affecting a service life of the recreational vehicle lock.

In view of the above problems, the present invention designs a waterproof and shakeproof electronic smart recreational vehicle lock, and this case is produced from this.

### SUMMARY

The present invention provides a waterproof and shakeproof electronic smart recreational vehicle lock, and the electronic recreational vehicle lock has the characteristics of high sealing and waterproof performance and shaking resistance; and specifically, the present invention is realized by the following technical solutions.

A waterproof and shakeproof electronic smart recreational vehicle lock comprises a lock body and an inner handle assembly connected with the lock body, wherein the lock body comprises a base, a fixed cover, a first locking structure and a second locking structure, the fixed cover and the base are assembled in a buckled mode, and a mounting cavity is formed between the fixed cover and the base; the inner handle assembly is mounted on a back surface of the fixed cover, the inner handle assembly comprises an inner plate, an inner handle and an unlocking knob, the inner plate is connected with the fixed cover, the inner handle is assembled and connected with the first locking structure, and the unlocking knob is assembled and connected with the second locking structure;

wherein the first locking structure comprises an outer handle, a first lock cylinder assembly assembled on the outer handle and a switch bolt; the switch bolt is assembled in the mounting cavity, the outer handle is assembled on a front surface of the base, and the outer handle and the inner handle control switching on and off of the switch bolt; the second locking structure comprises a second lock cylinder assembly, a safety bolt, a connecting assembly and an electronic locking device; the safety bolt and the connecting assembly are arranged in the mounting cavity, the unlocking knob is assembled on a back surface of the inner plate, the connecting assembly is connected with the second lock cylinder assembly, the safety bolt and the unlocking knob, and the unlocking knob and the second lock cylinder assembly control switching on and off of the safety bolt through the connecting assembly; the electronic locking device comprises a motor arranged in the mounting cavity, an operation panel arranged on the base and a circuit board arranged in the mounting cavity, and the motor is linked with the connecting assembly.

By arranging the fixed cover assembled with the base in the buckled mode, the mounting cavity is formed between the base and the fixed cover, and some parts corresponding to the recreational vehicle lock are accommodated in the mounting cavity, so that these parts are prevented from being eroded by external water, and circuit parts are prevented from being exposed at the same time, thus ensuring use safety, and compared with an exposed jumper wire of an existing electronic recreational vehicle lock, an overall safety performance of the recreational vehicle lock is increased.

Further, the connecting assembly comprises a connecting rod, a connecting shaft and a connecting rotary sleeve, the connecting rotary sleeve is sleeved on the connecting shaft, and the connecting rod is connected with the connecting rotary sleeve; one end of the connecting shaft is connected with the second lock cylinder assembly, and the other end of the connecting shaft is connected with the unlocking knob; an output shaft of the motor is connected with a worm, a worm gear is sleeved on the connecting shaft, the worm gear is connected with the connecting rotary sleeve in a friction transmission mode through the spring, and the worm gear is meshed with the worm.

The second lock cylinder assembly and the unlocking knob may both control switching on and off of the safety bolt through the connecting assembly.

Further, the electronic locking device further comprises a sound production structure arranged in the mounting cavity, and the sound production structure comprises a sound circuit board, a buzzer arranged on the sound circuit board and a shaking sound transmission sealing sleeve sleeved on the buzzer.

By arranging the shaking sound transmission sealing sleeve sleeved on the buzzer, sound produced by the buzzer is amplified, thus playing a role of prompting, and meanwhile, since the sound has been amplified, there is no need to form a sound production hole in the base, so that a loudness of the sound is increased, and external water is prevented from entering through the sound production hole; and meanwhile, the shaking sound transmission sealing sleeve may further seal and protect the buzzer, so that external water is prevented from entering the buzzer.

Further, the switch bolt is provided with a groove hole, a paddle on the outer handle passes through the base and is matched with the groove hole; the outer handle is hinged with the base through a connecting plate, the connecting plate is fixed with a mounting pin hole in the base through a connecting pin in interference fit, and the connecting plate is hinged with the outer handle; the first lock cylinder assembly is mounted on the outer handle, the first lock cylinder assembly is used for controlling a fixed or movable connection state between the outer handle and the base, when the first lock cylinder assembly is locked and fixed with the base, the outer handle is fixedly connected with the base; and when the first lock cylinder assembly is separated from the base, the outer handle is movably connected with the base.

The outer handle is hinged with the base through the connecting pin, and the connecting pin is in interference fit with the mounting pin hole in the base, thus preventing external water from flowing into the mounting cavity below the base through the mounting pin hole.

Further, the switch bolt is provided with the groove hole, a paddle on the inner handle passes through a fixed seat and is matched with the groove hole; the inner plate is connected with the fixed cover, the inner handle is hinged with the inner plate, and the fixed cover is provided with an inner handle opening for allowing the paddle of the inner handle to pass through; a back surface of the base is provided with a switch bolt mounting position for placing the switch bolt, a groove is formed on the switch bolt mounting position of the base, a waterproof rib is arranged at an outer peripheral edge of the handle opening in a front surface of the fixed cover, the waterproof rib on the fixed cover is clamped in the groove on the base, and the waterproof rib and the groove are in interference fit.

Since the inner handle outside the mounting cavity needs to pass through the fixed cover and enter the mounting cavity to toggle the switch bolt, external water may enter the mounting cavity through the inner handle opening formed in the fixed cover, and by interference fit between the waterproof rib on the fixed cover and the groove on the base, tight connection between the fixed cover at the opening and the base may be realized, so that water is prevented from entering the inside through a connecting gap between the fixed cover and the base.

Further, a water guide groove is arranged at an outer peripheral edge of the inner handle opening on a back surface of the fixed cover, the water guide groove is surrounded outside the inner handle opening, and one end of the water guide groove is communicated with a side of the fixed cover.

By arranging the water guide groove, a water flow at a peripheral edge of the inner handle opening is further led out smoothly.

Further, surfaces of the switch bolt and the safety bolt are both provided with a straight hole, a compression spring is arranged in the straight hole, a ball is placed on the compression spring, one end of the compression spring is contacted with a bottom portion of the straight hole, the other end of the compression spring is contacted with the ball, the ball is acted by an elastic force of the spring, and the ball abuts against a surface of the fixed cover or the base.

The switch bolt and the safety bolt are connected with the fixed cover or the base through the balls and the springs, and in the case of shaking, the springs play a role of buffering, which reduces shaking of the bolts, prevents a direct hard collision between the bolts and the fixed cover or the base, plays a role of shaking resistance, and also prevents noise production; and meanwhile, arrangement of the balls may not hinder normal movements of the bolts, and the balls may be rotated along with the movements of the bolts, with an operation performance and a shaking resistance performance at the same time.

Further, the connecting rotary sleeve is provided with an assembly ring, an axis of the assembly ring is parallel to an axis of the connecting rotary sleeve, and two ends of the connecting rod are bent, wherein one bent end is assembled in the assembly ring, and the other bent end is assembled in the groove hole on the safety bolt.

Connection of this structure converts rotation of the connecting shaft into linear movements of the bolts.

Further, the sound circuit board is connected with the control circuit board through a flexible flat cable.

Existing two circuit boards are bridged in the air by a harness wire with a poor flexibility, so that the connection is unstable and dangerous; and in the present invention, the two circuits are connected by the flexible flat cable, and based on characteristics such as softness of the flexible flat cable, the flexible flat cable is suitable for a narrow space and has a good connection stability.

Further, the fixed cover is provided with a power supply port, the power supply port is connected with the circuit board on the electronic locking device, and a vehicle-mounted power supply supplies power to the electronic locking device through the power supply port.

The power supply port is reserved, which is convenient for the vehicle-mounted power supply to supply power to the electronic recreational vehicle lock.

Further, a back portion of the operation panel is provided with a panel pad.

Since the operation panel is arranged on the surface of the base and exposed in an external space, the operation panel is used for an operator to input an unlocking or locking instruction, so that a joint between the operation panel and the base is easily invaded by external water, thus affecting the circuit board below the operation panel, and the joint between the operation panel and the base may be effectively sealed through the arranged panel pad, thus playing a role of waterproofing.

Further, a clamp spring is mounted on the connecting shaft, and the connecting sleeve on the connecting shaft and the worm gear are prevented from moving axially by the clamp spring; and the clamp spring is arranged in the mounting cavity, a clamp spring seat is arranged on a front surface of a fixed sleeve, the clamp spring is mounted in the clamp spring seat, and the clamp spring seat limits a movement of the clamp spring.

By arranging the fixed sleeve sleeved on the connecting shaft, and arranging the clamping spring seat on the fixed sleeve to assemble the clamp spring, the clamp spring may be effectively prevented from being separated from the connecting shaft, thus ensuring connection firmness of parts.

Further, the electronic locking device selects a battery as a power supply source, the inner plate is provided with a battery seat, and the battery is mounted in the battery seat; and a battery seat opening is tightly assembled with a battery seat plate in a buckled mode, and an inner surface of the battery seat plate is provided with an anti-shake pad.

The battery seat plate is connected with the inner plate in the buckled mode, which may close the battery seat opening and ensure a stability of the connection at the same time, and meanwhile, an inner surface of the battery seat plate is provided with the anti-shake pad, so that no abnormal sound may be produced during running and shaking of the vehicle.

Further, the second lock cylinder assembly is assembled on the base, and an O-shaped ring for sealing is arranged at an assembly joint between the second lock cylinder assembly and the base.

The O-shaped ring may seal a connecting gap between the second lock cylinder assembly and the base to prevent invasion of external water.

Further, the fixed cover has an integrated structure, and is made of plastic.

The fixed cover adopts an integrated structure design, may achieve a good sealing performance after mounting, and is convenient to mount at the same time; and the fixed cover is made of the plastic, and due to characteristics of the plastic, in the case of shaking of the recreational vehicle lock, an elasticity of the plastic may play a certain role of buffering, so that even if there is a collision, produced sound is not loud.

### BRIEF DESCRIPTION OF THE DRAWINGS

FIG. 1 is a stereoscopic diagram of an embodiment of a waterproof and shakeproof electronic smart recreational vehicle lock provided by the present invention;

FIG. 2 is an exploded view of the embodiment of the waterproof and shakeproof electronic smart recreational vehicle lock provided by the present invention;

FIG. 3 is a stereoscopic diagram of the embodiment of the waterproof and shakeproof electronic smart recreational vehicle lock provided by the present invention from another perspective;

FIG. 4 is a front view of the embodiment of the waterproof and shakeproof electronic smart recreational vehicle lock provided by the present invention;

FIG. 5 is a cross-sectional view in a J-J direction of FIG. 4;

FIG. 6 is a cross-sectional view in an A-A direction of FIG. 4;

FIG. 7 is a cross-sectional view in a B-B direction of FIG. 4;

FIG. 8 is a cross-sectional view in an L-L direction of FIG. 4;

FIG. 9 is an exploded view of the embodiment of the waterproof and shakeproof electronic smart recreational vehicle lock provided by the present invention;

FIG. 10 is an exploded view of the embodiment of the waterproof and shakeproof electronic smart recreational vehicle lock provided by the present invention.

1 refers to inner handle assembly; 2 refers to lock body; 3 refers to base; 4 refers to fixed cover; 5 refers to first locking structure; 6 refers to second locking structure; 7 refers to mounting cavity; 8 refers to inner plate; 9 refers to inner handle; 10 refers to unlocking knob; 11 refers to outer handle; 12 refers to first lock cylinder assembly; 13 refers to switch bolt; 14 refers to switch bolt mounting position; 15 refers to paddle; 16 refers to pin hole; 17 refers to connecting pin; 18 refers to inner handle opening; 19 refers to waterproof rib; 20 refers to groove; 21 refers to water guide groove; 22 refers to second lock cylinder assembly; 23 refers to safety bolt; 24 refers to connecting assembly; 25 refers to connecting rod; 26 refers to connecting shaft; 27 refers to connecting rotary sleeve; 28 refers to electronic locking device; 29 refers to motor; 30 refers to worm; 31 refers to worm gear; 32 refers to control circuit board; 33 refers to operation panel; 34 refers to panel pad; 35 refers to clamp spring; 36 refers to sound production structure; 37 refers to sound circuit board; 38 refers to buzzer; 39 refers to shaking and sound transmission sealing sleeve; 40 refers to battery; 41 refers to battery seat; 42 refers to battery seat plate; 43 refers to anti-shake pad; 44 refers to compression spring; 45 refers to ball; 46 refers to assembly ring; 47 refers to O-shaped ring; 48 refers to connecting plate; 49 refers to spring; 50 refers to elastic sheet; and 51 refers to clamping position.

### DETAILED DESCRIPTION

The present invention is further described hereinafter with reference to the drawings and the specific implementations.

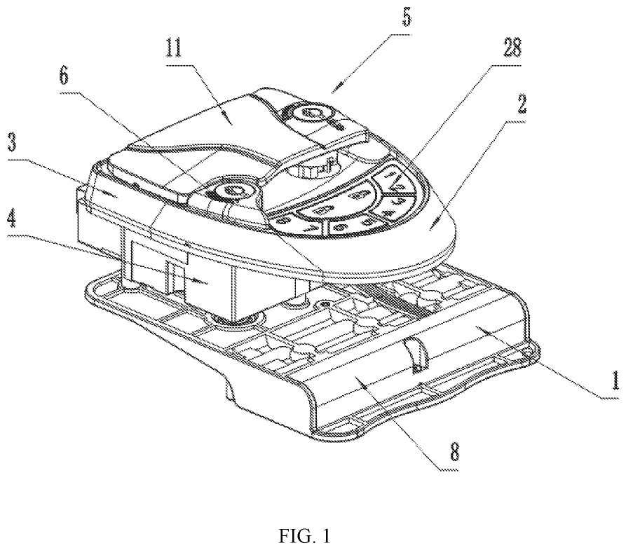

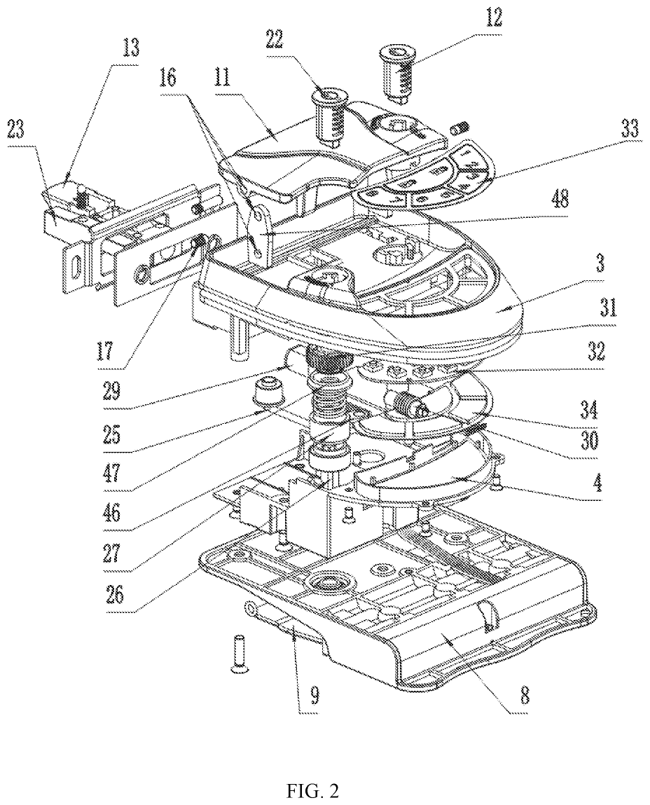

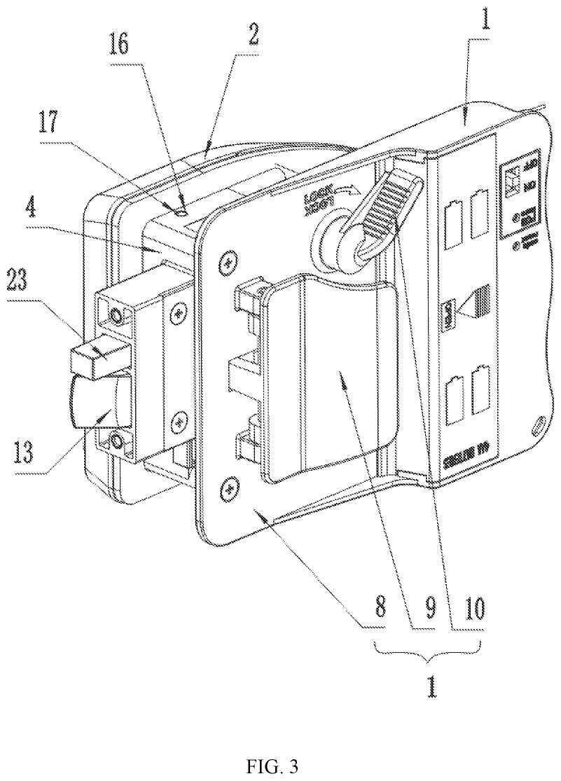

As shown in FIG. 1, FIG. 2 and FIG. 3, a waterproof and shakeproof electronic intelligent recreational vehicle lock comprises a lock body 2 embedded in a door panel and an inner handle assembly 1 assembled on an inside surface of the door panel. According to a position where the recreational vehicle lock is mounted on the door, a surface facing an outside surface of the door after mounting is regarded as a front surface of the recreational vehicle lock, and a surface facing the inside surface of the door after mounting is regarded as a back surface of the recreational vehicle lock. The lock body 2 comprises a base 3, a fixed cover 4, a first locking structure 5 and a second locking structure 6. A front surface of the fixed cover 4 and a back surface of the base 3 are assembled in a buckled mode, a mounting cavity 7 is formed between the fixed cover and the base, and the mounting cavity 7 is used for placing various related parts corresponding to the lock body 2. The inner handle assembly 1 is mounted on a back surface of the fixed cover 4, and the inner handle assembly 1 comprises an inner plate 8, an inner handle 9 and an unlocking knob 10. The inner plate 8 is connected with the fixed cover 4, as shown in FIG. 3. The inner handle 9 is assembled and connected with the first locking structure 5, and the unlocking knob 10 is assembled and connected with the second locking structure 6.

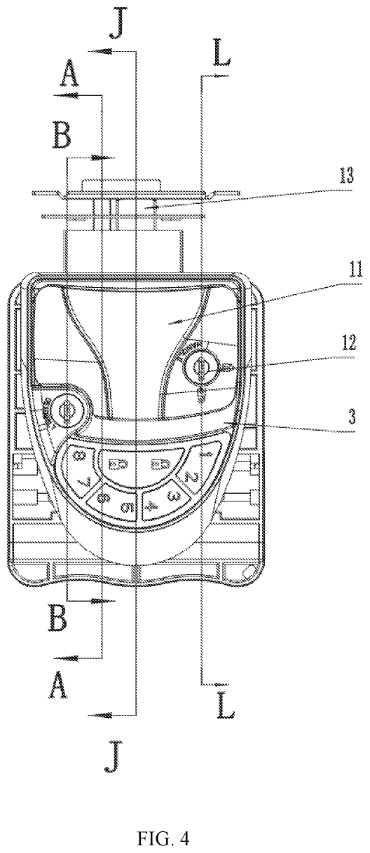

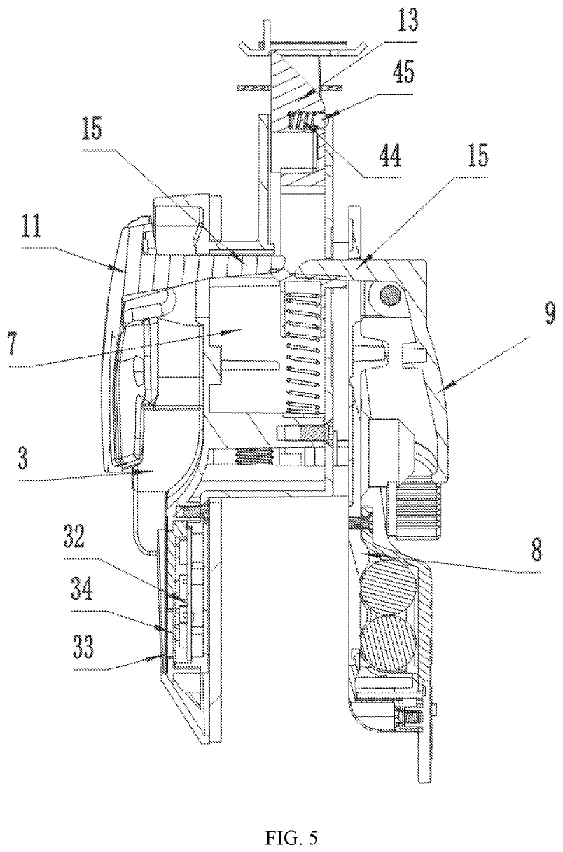

As shown in FIG. 4 and FIG. 5, the first locking structure 5 comprises an outer handle 11, a first lock cylinder assembly 12 assembled on the outer handle 11 and a switch bolt 13. The switch bolt 13 is assembled in the mounting cavity 7, the outer handle 11 is assembled on a front surface of the base 3, and the outer handle 11 and the inner handle 9 control a movement of the switch bolt 13, thus controlling switching on and off of the switch bolt 13. A specific connection mode is as follows.

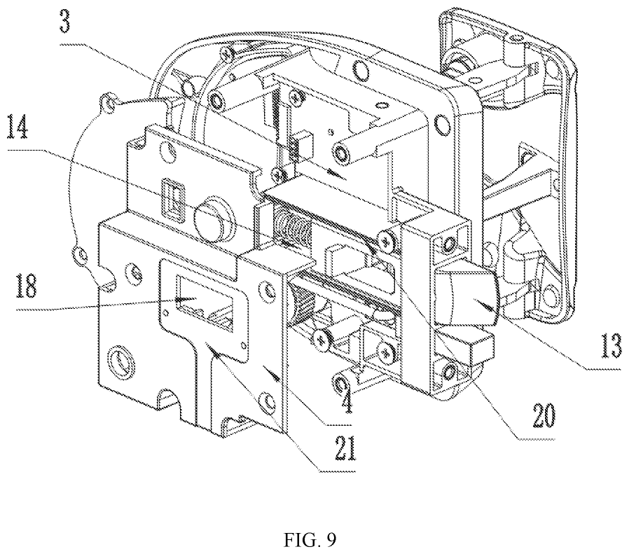

As shown in FIG. 5 and FIG. 9, the back surface of the base 3 is provided with a switch bolt mounting position 14, and the switch bolt 13 is assembled in the switch bolt mounting position 14 of the base 3. A side of the base 3 is provided with an opening for the switch bolt 13 to enter and withdraw, and the switch bolt 13 moves linearly, and enters and withdraws from the mounting cavity 7 to achieve a locking or unlocking effect. The switch bolt 13 is provided with a groove hole perpendicular to a linear movement direction of the switch bolt 13, a paddle 15 on the outer handle 11 passes through the base 3 and is matched with the groove hole, and a paddle 15 on the inner handle 9 passes through the fixed cover 4 and is matched with the groove hole. By a movement of the outer handle 11 or the inner handle 9, the corresponding paddle 15 is controlled to toggle the switch bolt 13, thus realizing the linear movement of the switch bolt 13, and controlling the switching on and off of the switch bolt 13.

As shown in FIG. 5, the outer handle 11 is assembled on the front surface of the base 3, and one end of the outer handle 11 is hinged with the base 3. As shown in FIG. 2 and FIG. 3, specifically, the side of the base 3 is provided with a pin hole 16, a connecting plate 48 is provided with two pin holes 16, and a connecting plate of the outer handle 11 is provided with a pin hole 16. One pin hole 16 in the connecting plate 48 is matched with the pin hole 16 in the base 3, and a connecting pin 17 is in interference fit with one pin hole 16 in the connecting plate 48 and the pin hole 16 in the base 3 to realize fixed connection between the connecting plate and the base. The other pin hole 16 in the connecting plate 48 is matched with the pin hole 16 in the outer handle 11 to movably connect the connecting plate with the outer handle. The outer handle 11 may be rotated relative to the base 3, and the rotation of the outer handle 11 drives the paddle 15 on the outer handle 11 to toggle the switch bolt 13, as shown in FIG. 5. Since the connecting pin 17 is in interference fit with the pin hole 16 in the base 3, as shown in FIG. 2, a joint between the connecting pin and the pin hole in the base is completely sealed without a gap, so that external water cannot enter the mounting cavity 7 through the pin hole 16 in the base 3.

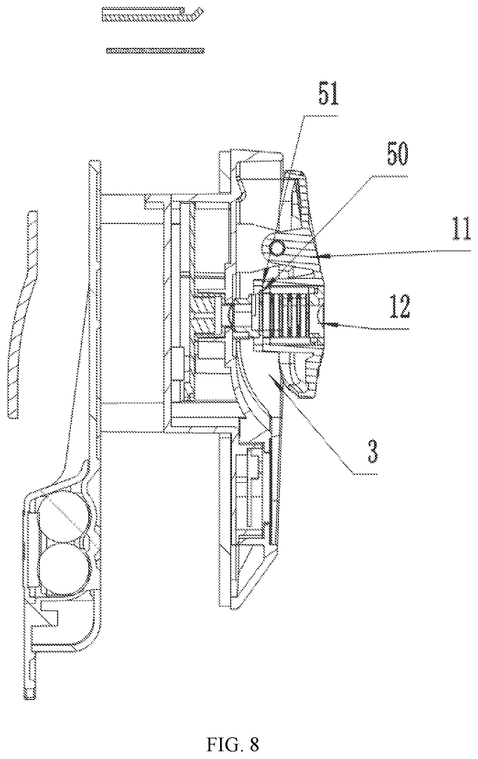

As shown in FIG. 8, the first lock cylinder assembly 12 is mounted on the outer handle 11, the base 3 is provided with a hole matched with the first lock cylinder assembly 12, and the first lock cylinder assembly 12 is used for controlling fixed or movable connection between the outer handle 11 and the base 3. When the first lock cylinder assembly 12 is assembled in the hole matched with the first lock cylinder assembly 12, and locked and fixed with the base 3, the outer handle 11 is locked and fixed with the base 3. When the first lock cylinder assembly 12 is opened and separated from the base 3, the outer handle 11 is movably connected with the base 3, and the outer handle 11 may be rotated relative to the base 3.

The inner plate 8 is fixedly connected with the fixed cover 4, and the inner handle 9 is rotatably and movably connected with the inner plate 8. Specifically, hinged connection through a shaft hole is used, so that the inner handle 9 may be rotated relative to the inner plate 8, and the rotation of the inner handle 9 drives the paddle 15 on the inner handle 9 to toggle the switch bolt 13, thus realizing the linear movement of the switch bolt 13 and controlling the switching on and off of the switch bolt 13, as shown in FIG. 5.

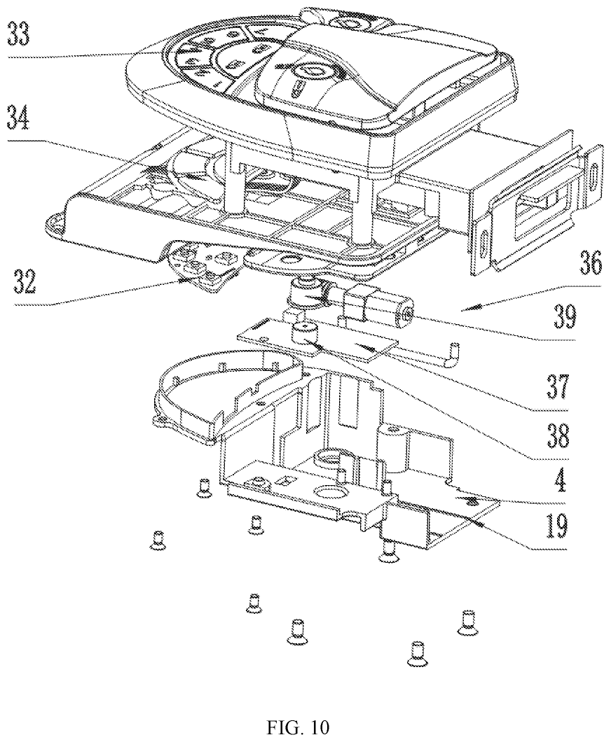

As shown in FIG. 9 and FIG. 10, in the fixed cover 4, an inner handle opening 18 is formed at an assembly position between the fixed cover and the switch bolt mounting position 14 of the base 3 for the paddle 15 of the inner handle 9 to pass through so as to toggle the switch bolt 13. A waterproof rib 19 is arranged at an outer peripheral edge of the inner handle opening 18 in the front surface of the fixed cover 4, and a groove 20 is formed on the switch bolt mounting position 14 of the base 3. When the base 3 is assembled with the fixed cover 4 in a closed mode, the waterproof rib 19 on the fixed cover 4 is clamped in the groove 20 on the base 3, and the waterproof rib and the groove are in interference fit to realize tight connection, so that external water is prevented from entering the mounting cavity 7 through a connecting gap between the waterproof rib and the groove.

In order to further prevent external water from entering the mounting cavity 7 through the inner handle opening 18 in the fixed cover 4, a water guide groove 21 is arranged at an outer peripheral edge of the inner handle opening 18 on the back surface of the fixed cover 4, the water guide groove 21 is surrounded outside the inner handle opening 18, and meanwhile, one end of the water guide groove 21 is communicated with a side of the fixed cover 4, so that water around the inner handle opening 18 is drained to the side of the fixed cover 4 to flow out.

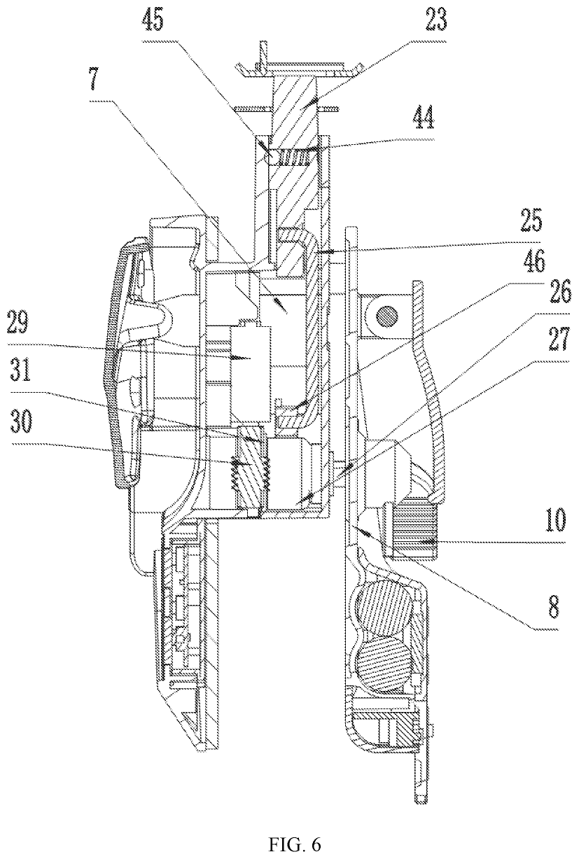

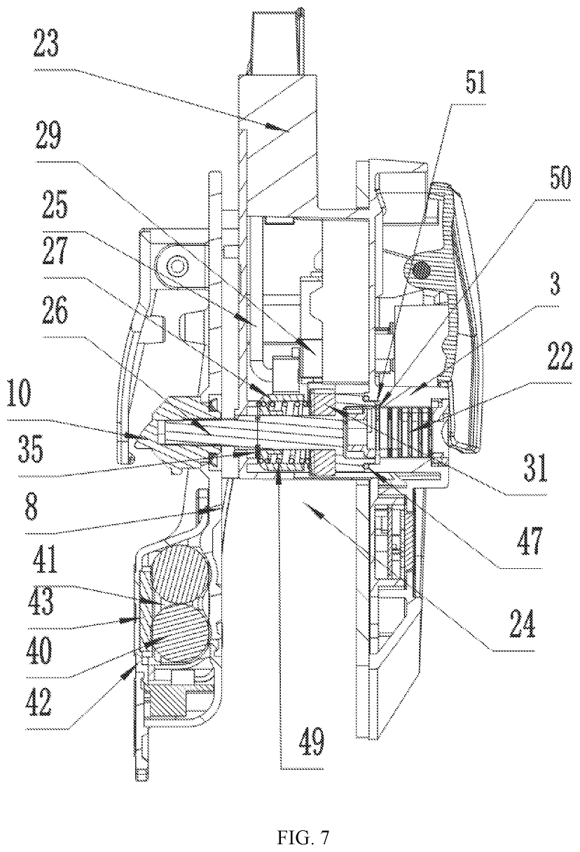

As shown in FIG. 6 and FIG. 7, the second locking structure 6 comprises a second lock cylinder assembly 22, a safety bolt 23 and a connecting assembly 24. The safety bolt 23 is assembled in the mounting cavity 7, the unlocking knob 10 is assembled on a back surface of the inner plate 8, the second lock cylinder assembly 22 passes through the base 3 and the fixed cover 4 to be assembled in the mounting cavity 7, the connecting assembly 24 is arranged in the mounting cavity 7, the connecting assembly 24 is connected with the second lock cylinder assembly 22, the safety bolt 23 and the unlocking knob 10, and the unlocking knob 10 and the second lock cylinder assembly 22 control a movement of the safety bolt 23, thus controlling switching on and off of the safety bolt 23. A specific connection mode is as follows.

As shown in FIG. 6 and FIG. 7, the side of the base 3 is provided with an opening for the safety bolt 23 to enter and withdraw, and the safety bolt 23 moves linearly, and enters and withdraws from the mounting cavity 7 to achieve a locking or unlocking effect. The safety bolt 23 is provided with a groove hole, the connecting assembly 24 is connected with the groove hole, and meanwhile, the connecting assembly 24 is also connected with the second lock cylinder assembly 22 and the unlocking knob 10. The second lock cylinder assembly 22 and the unlocking knob 10 control the switching on and off of the safety bolt 23 through the connecting assembly 24. As shown in FIG. 7, the second lock cylinder assembly 22 is assembled on the base 3, and an O-shaped ring 47 for sealing is arranged at an assembly joint between the second lock cylinder assembly and the base for waterproofing.

As shown in FIG. 1, the connecting assembly 24 comprises a connecting rod 25, a connecting shaft 26 and a connecting rotary sleeve 27. As shown in FIG. 6 and FIG. 7, the connecting rotary sleeve 27 is sleeved on the connecting shaft 26, the connecting rod 25 is assembled on the connecting rotary sleeve 27, one end of the connecting shaft 26 is connected with the second lock cylinder assembly 22, and the other end of the connecting shaft 26 is connected with the unlocking knob 10. The rotation of the second lock cylinder assembly 22 or the unlocking knob 10 drives the connecting shaft 26 to rotate, and then drives the connecting rod 25 to move, and the movement of the connecting rod 25 drive the safety bolt 23 to move, thus controlling the switching on and off of the safety bolt 23.

As shown in FIG. 6 and FIG. 7, the connecting rotary sleeve 27 is provided with an assembly ring 46, an axis of the assembly ring 46 is parallel to an axis of the connecting rotary sleeve 27, and two ends of the connecting rod 25 are bent, wherein one bent end is assembled in the assembly ring 46, and the other bent end is assembled in the groove hole on the safety bolt 23. The rotation of the connecting rotary sleeve 27 drives one end of the connecting rod 25 to rotate around the connecting shaft 26, and the other end of the connecting rod 25 drives the safety bolt 23 to move linearly.

As shown in FIG. 1, the second locking structure 6 further comprises an electronic locking device 28, the electronic locking device 28 further controls the switching on and off of the safety bolt 23 by controlling the rotation of the connecting assembly 24. As shown in FIG. 2, the electronic locking device 28 comprises a motor 29, a worm 30 connected onto an output shaft of the motor 29, a worm gear 31 meshed with the worm 30, a control circuit board 32 for controlling running of the motor 29, and an operation panel 33. As shown in FIG. 5, the base 3 is provided with an operation panel mounting seat, the operation panel 33 is mounted in the operation panel mounting seat on the front surface of the base 3, and a panel pad 34 is mounted on a back surface of the operation panel 33 to play roles of waterproofing and sealing. Meanwhile, the control circuit board 32 is arranged in the mounting cavity 7, the panel pas 34 may prevent water from flowing into the back surface of the base 3 to erode the control circuit board 32, and the worm gear 31 and the worm 30 are also arranged in the mounting cavity 7. A locking or unlocking command is input through the operation panel 33, the command is transmitted to the control circuit board 32, and the circuit board 32 controls a movement of the motor 29. As shown in FIG. 7, the worm gear 31 is assembled on the connecting shaft 26 of the connecting assembly 24, and the worm gear 31 is connected with the connecting rotary sleeve 27 in a friction transmission mode. Specifically, the worm gear 31 is sleeved outside the connecting shaft 26, a spring 49 is sleeved outside the connecting shaft 26, the spring 49 is located between the connecting rotary sleeve 27 and the worm gear 31, one end of the spring 49 abuts against the connecting rotary sleeve 27, and the other end of the spring abuts against the worm gear 31. When the worm gear 31 is rotated, a torque is transmitted to the connecting rotary sleeve 27 through the spring 49, thus driving the connecting rotary sleeve 27 to rotate.

When a load torque on the connecting rotary sleeve 27 exceeds the torque transmitted by the worm gear 31 to the connecting rotary sleeve 27 through the spring 49, the worm gear 31 and the connecting rotary sleeve 27 are separated in running, and only the motor 29 drives the worm gear 31 to rotate, but the connecting rotary sleeve 27 is not rotated. When the load torque on the connecting rotary sleeve 27 is smaller than the torque transmitted by the worm gear 31 to the connecting rotary sleeve 27 through the spring 49, the worm gear 31 drives the connecting rotary sleeve 27 to rotate through static friction, which is converted into the linear movement of the safety bolt 23.

As shown in FIG. 7, a clamp spring 35 is mounted on the connecting shaft 26, and the connecting sleeve on the connecting shaft 26 and the worm gear 31 are prevented from moving axially by the clamp spring 35. The clamp spring 35 is arranged in the mounting cavity 7, a clamp spring seat is arranged on a front surface of a fixed sleeve, the clamp spring 35 is mounted in the clamp spring seat, and the clamp spring seat limits a movement of the clamp spring 35, so that the clamp spring 35 may be prevented from falling off the connecting shaft 26 due to shaking.

As shown in FIG. 10, the electronic locking device 28 further comprises a sound production structure 36, the sound production structure 36 is arranged in the mounting cavity 7 and connected with the control circuit board 32, and with an operation of a user on the operation panel 33, the sound production structure 36 produces operation sound. The sound production structure 36 comprises a sound circuit board 37, a buzzer 38 arranged on the sound circuit board 37 and a shaking sound transmission sealing sleeve 39 sleeved on the buzzer 38. With shaking of the buzzer 38, the shaking sound transmission sealing sleeve 39 is driven to shake and produce sound, and meanwhile, the shaking sound transmission sealing sleeve 39 may protect the buzzer 38 from erosion of external rain water. The sound circuit board 37 is connected with the control circuit board 32 through a flexible flat cable. Meanwhile, the fixed cover 4 is provided with a power supply port, the power supply port is connected with the circuit board on the electronic locking device 28, and a vehicle-mounted power supply supplies power to the electronic locking device 28 through the power supply port.

As shown in FIG. 7, the electronic locking device 28 may also select a battery 40 as a power supply source, the inner plate 8 is provided with a battery seat 41, and the battery 40 is mounted in the battery seat 41. A battery seat opening is tightly assembled with a battery seat plate 42 in a buckled mode, and an inner surface of the battery seat plate 42 is provided with an anti-shake pad 43 to play roles of anti-shaking and buffering, thus preventing parts from colliding to produce sound.

As shown in FIG. 3, the electronic locking device 28 further comprises a remote control switch, a remote control code pairing key and a system reset key arranged on the inner plate 8, and the remote control switch, the remote control code pairing key and the system reset key are connected with the control circuit board 32.

The fixed cover 4 has an integrated structure, and is made of plastic, thus having a certain elasticity. Therefore, in the case of shaking of the recreational vehicle lock, the fixed cover may play roles of buffering and anti-shaking.

The safety bolt 23 and the switch bolt 13 are arranged in the mounting cavity 7 formed by assembling the fixed cover 4 and the base 3. In the safety bolt 23 and the switch bolt 13, when the lock is subjected to external shaking, the bolts shake in the mounting cavity 7 at the same time, and may have a hard touch with the fixed cover 4 or the base 3 to produce sound. Therefore, shaking of the bolts may be relieved by setting the following structure, so that the bolts are prevented from colliding with the fixed cover 4 or the base 3 to produce sound. As shown in FIG. 5 and FIG. 6, side surfaces of the bolts are both provided with a straight hole, a compression spring 44 is mounted in the straight hole, and a ball 45 is placed on the compression spring 44. One end of the compression spring 44 is contacted with a bottom portion of the straight hole, and the other end of the compression spring 44 is contacted with the ball 45. The ball 45 is acted by an elastic force of the spring, and the ball 45 is contacted with an inner surface of the fixed cover 4 or the base 3, which means that the ball 45 abuts against the inner surface of the fixed cover 4 or the base 3. When the bolts are subjected to external shaking, the spring plays a role of buffering, and arrangement of the ball 45 may not hinder linear running of the bolts.

The first lock cylinder assembly 12 and the second lock cylinder assembly 22 are both a detachable lock cylinder assembly. Specifically, as shown in FIG. 8, one end of the first lock cylinder assembly 12 is provided with a telescopic elastic sheet 50, and a clamping position 51 is arranged in an assembly hole of the first lock cylinder assembly 12 formed on the outer handle 11. When the first lock cylinder assembly 12 is assembled in the assembly hole of the first lock cylinder assembly 12, the elastic sheet 50 extends out and is clamped in the clamping position 51 in the assembly hole of the first lock cylinder assembly 12. During disassembly, the telescopic elastic sheet 50 of the first lock cylinder assembly 12 is triggered to retract inwardly. Meanwhile, the first lock cylinder assembly 12 is pulled outwardly, so that the telescopic elastic sheet 50 is separated from the clamping position 51, and then the first lock cylinder assembly 12 is separated from the assembly hole in the outer handle 11.

As shown in FIG. 7, similarly, one end of the second lock cylinder assembly 22 is provided with a telescopic elastic sheet 50, and a clamping position 51 is arranged in an assembly hole of the second lock cylinder assembly 22 formed on the base 3. When the second lock cylinder assembly 22 is assembled in the assembly hole of the second lock cylinder assembly 22, the elastic sheet 50 extends out and is clamped in the clamping position 51 in the assembly hole of the second lock cylinder assembly 22. During disassembly, the telescopic elastic sheet 50 of the second lock cylinder assembly 22 is triggered to retract inwardly. Meanwhile, the second lock cylinder assembly 22 is pulled outwardly, so that the telescopic elastic sheet 50 is separated from the clamping position 51, and then the second lock cylinder assembly 22 is separated from the assembly hole in the base 3.

The foregoing is only the preferred implementations of the present invention, and several other simple substitutions and modifications made on the premise of the concept of the present invention should all be regarded as belonging to the scope of protection of the present invention.

1. A waterproof and shakeproof electronic smart recreational vehicle lock, comprising a lock body and an inner handle assembly connected with the lock body, wherein the lock body comprises a base, a fixed cover, a first locking structure and a second locking structure, the fixed cover and the base are assembled in a buckled mode, and a mounting cavity is formed between the fixed cover and the base; the inner handle assembly is mounted on a back surface of the fixed cover, the inner handle assembly comprises an inner plate, an inner handle and an unlocking knob, the inner plate is connected with the fixed cover, the inner handle is assembled and connected with the first locking structure, and the unlocking knob is assembled and connected with the second locking structure;
wherein the first locking structure comprises an outer handle, a first lock cylinder assembly assembled on the outer handle and a switch bolt; the switch bolt is assembled in the mounting cavity, the outer handle is assembled on a front surface of the base, and the outer handle and the inner handle control switching on and off of the switch bolt; the second locking structure comprises a second lock cylinder assembly, a safety bolt, a connecting assembly and an electronic locking device; the safety bolt and the connecting assembly are arranged in the mounting cavity, the unlocking knob is assembled on a back surface of the inner plate, the connecting assembly is connected with the second lock cylinder assembly, the safety bolt and the unlocking knob, and the unlocking knob and the second lock cylinder assembly control switching on and off of the safety bolt through the connecting assembly; the electronic locking device comprises a motor arranged in the mounting cavity, an operation panel arranged on the base and a control circuit board arranged in the mounting cavity, and the motor is linked with the connecting assembly;
a paddle on the inner handle passes through a fixed seat and is matched with the switch bolt; the inner handle is hinged with the inner plate, and the fixed cover is provided with an inner handle opening for allowing the paddle of the inner handle to pass through; a back surface of the base is provided with a switch bolt mounting position for placing the switch bolt, a groove is formed on the switch bolt mounting position of the base, a waterproof rib is arranged at an outer peripheral edge of the handle opening in a front surface of the fixed cover, the waterproof rib on the fixed cover is clamped in the groove on the base, and the waterproof rib and the groove are in interference fit;
a paddle on the outer handle passes through the base and is matched with the switch bolt; the outer handle is hinged with the base through a connecting plate, the connecting plate is fixed with a mounting pin hole in the base through a connecting pin in interference fit, and the connecting plate is hinged with the outer handle; the first lock cylinder assembly is mounted on the outer handle, the first lock cylinder assembly is used for controlling a fixed or movable connection state between the outer handle and the base, when the first lock cylinder assembly is locked and fixed with the base, the outer handle is fixedly connected with the base; when the first lock cylinder assembly is separated from the base, the outer handle is movably connected with the base;
a water guide groove is arranged at an outer peripheral edge of the inner handle opening on a back surface of the fixed cover, the water guide groove is surrounded outside the inner handle opening, and one end of the water guide groove is communicated with a side of the fixed cover;
surfaces of the switch bolt and the safety bolt are both provided with a straight hole, a compression spring is arranged in the straight hole, a ball is placed on the compression spring, one end of the compression spring is contacted with a bottom portion of the straight hole, the other end of the compression spring is contacted with the ball, the ball is acted by an elastic force of the spring, and the ball abuts against a surface of the fixed cover or the base; and
the electronic locking device further comprises a sound production structure arranged in the mounting cavity, and the sound production structure comprises a sound circuit board, a buzzer arranged on the sound circuit board and a shaking sound transmission sealing sleeve sleeved on the buzzer.

2. The waterproof and shakeproof electronic smart recreational vehicle lock according to claim 1, wherein the connecting assembly comprises a connecting rod, a connecting shaft and a connecting rotary sleeve, the connecting rotary sleeve is sleeved on the connecting shaft, and the connecting rod is connected with the connecting rotary sleeve; one end of the connecting shaft is connected with the second lock cylinder assembly, and the other end of the connecting shaft is connected with the unlocking knob; an output shaft of the motor is connected with a worm, a worm gear is sleeved on the connecting shaft, the worm gear is connected with the connecting rotary sleeve in a friction transmission mode through the spring, and the worm gear is meshed with the worm; a clamp spring is mounted on the connecting shaft, and the connecting sleeve on the connecting shaft and the worm gear are prevented from moving axially by the clamp spring; and the clamp spring is arranged in the mounting cavity, a clamp spring seat is arranged on a front surface of a fixed sleeve, and the clamp spring is mounted in the clamp spring seat.

3. The waterproof and shakeproof electronic smart recreational vehicle lock according to claim 1, wherein the sound circuit board is connected with the control circuit board through a flexible flat cable.

4. The waterproof and shakeproof electronic smart recreational vehicle lock according to claim 1, wherein the fixed cover is provided with a power supply port, the power supply port is connected with the circuit board on the electronic locking device, and a vehicle-mounted power supply supplies power to the electronic locking device through the power supply port.

5. The waterproof and shakeproof electronic smart recreational vehicle lock according to claim 1, wherein a back portion of the operation panel is provided with a panel pad.

6. The waterproof and shakeproof electronic smart recreational vehicle lock according to claim 1, wherein the inner plate is provided with a battery seat, and a battery is mounted in the battery seat; and a battery seat opening is tightly assembled with a battery seat plate in a buckled mode, and an inner surface of the battery seat plate is provided with an anti-shake pad.

7. The waterproof and shakeproof electronic smart recreational vehicle lock according to claim 1, wherein the second lock cylinder assembly is assembled on the base, and an O-shaped ring for sealing is arranged at an assembly joint between the second lock cylinder assembly and the base.

8. The waterproof and shakeproof electronic smart recreational vehicle lock according to claim 1, wherein the fixed cover has an integrated structure, and is made of plastic.
